(19) United States
(12) Patent Application Publication
(10) Pub. No.: US 2019/0225376 A1
(43) Pub. Date: Jul. 25, 2019

(54) ONE-USE BOTTLE-HOLDER FOR TEMPORARY ATTACHMENT TO AN OBJECT

(71) Applicant: CTB Denmark ApS, Nivå (DK)

(72) Inventor: Henrik Mondrup-Kristiansen, Copenhagen (DK)

(73) Assignee: CTB Denmark ApS, Nivå (DK)

(21) Appl. No.: 16/317,513

(22) PCT Filed: Jun. 13, 2017
(86) PCT No.: PCT/DK2017/050194

§ 371 Date: Jan. 11, 2019

(30) Foreign Application Priority Data
Jul. 13, 2016 (DK) PA201670519

(51) Int. Cl. B65D 23/08; F16B 2/08; A47G 23/02; B65D 23/00

(52) U.S. Cl. CPC B65D 23/0842; B65D 23/003; A47G 23/0241; F16B 2/08

(57) ABSTRACT

In the field of bottle-holders for temporary attachment to an object there is disclosed a one-use cardboard bottle-holder formed from a cardboard sleeve comprising cutouts and fold lines, wherein when the cutouts are released from attachment to the cardboard sleeve, and the same cutouts are folded along the fold lines, a one-use bottle-holder for temporary attachment to an object is formed.

### FIELD

In the field of bottle-holders there is disclosed an attachable and detachable bottle-holder for temporary attachment to stationary or movable objects.

### BACKGROUND

Bottle-holders for permanent installation on bicycles, the bottle-holders made from e.g. metals or hard plastics, are commonplace, daily objects, which over the years have been installed on many bicycles. Bottle-holders of the prior art provide storing space for and easy access to drinking fluids during biking, where otherwise one hand would be permanently dedicated to carrying drinking bottles rather than for steering.

However, in the market for bottle-holders there is a lack of solutions available, which are directed at solving the problem of what to do with a drinking bottle in transport situations, e.g. when riding a bicycle, where the hands of a user are not free or available to carry the bottle, but where the user's bicycle does not come with a preinstalled bottle-holder.

In the art, there are known a large number of reusable bottle-holders, both for temporary attachment to an object, such as e.g. a bicycle, or for permanent attachment to an object, such as e.g. a bicycle, but in many situations, a user of the object, for aesthetic, practical or economic reasons, may not desire to install bottle-holders permanently on his objects, e.g. on the aforementioned bicycle, or may simply find himself without a bottle-holder at his disposal when needed. The present invention present solutions aimed at overcoming this deficiency.

Accordingly, the present inventor has identified a need in the market for one-use bottle-holders, which can be manufactured in a simple manner, and which are inexpensively enough for a user to purchase for one-time use purposes. A further advantage relates to the ease of assembling a bottle-holder according to the invention, which can be done in manners suitable for one-time use.

In a first aspect and embodiment, the invention relates to a one-use cardboard bottle-holder for temporary attachment to an object.

In a second aspect and embodiment, the invention relates to a cardboard sleeve comprising cutouts and fold lines, wherein when the cutouts are released from attachment to the cardboard sleeve, and the same cutouts are folded along the fold lines, a one-use bottle-holder for temporary attachment to an object is formed.

In a third embodiment, the invention relates to a cardboard sheet comprising cutouts and fold lines, which can be folded into an elongated cardboard body in accordance with the first embodiment of the invention.

In a fourth embodiment, the invention relates to a method of folding a one-use cardboard bottle-holder from a cardboard sheet comprising cutouts and fold lines, by forming the elongated cardboard body from the cardboard sheet, releasing the cutouts from attachment to the cardboard body, and folding the same cutouts along the fold lines, to form a one-use bottle-holder for temporary attachment to an object.

### SUMMARY OF THE INVENTION

In accordance with a first aspect and embodiment of the invention, there is disclosed a one-use bottle-holder (1) comprising: a cardboard sleeve (10), the sleeve forming an open, hollow cylinder around a cylinder center axis (CA) thereby defining an interior void (11) for receiving a bottle, and a first opening (12) and a second opening (13); a first strip (21) and a second strip (25) respectively arranged on the cardboard sleeve (10) towards the first opening (12), wherein on the first strip (21) there is arranged at least one first joining means (22a-1), and on the second strip (25) there is arranged at least one second and opposing joining means (26a-c), such that when the at least one first joining means (22a-1) is brought into engagement with the at least one second and opposing joining means (26a-c) a fastener (20) is formed; and at least a first support cutout (30a) and a second support cutout (30b), each the support cutout hingedly attached at two opposing ends (31a,31e; 31f,31j) to the cardboard sleeve (10) such that each support cutout (30a,30b) is displaceable between a first position, wherein a the support cutout (30a,30b) forms a part of the cardboard sleeve (10) and a second position, wherein a the support cutout (30a,30b) forms a part of a bottle-holder bottom (30), and wherein each respective hinged attachment end (31a,31e;31f,31j) respectively rotates around a respective axis, each respective axis aligned in parallel to the center axis.

In accordance with a second embodiment of the first aspect and embodiment, there is disclosed a one-use bottle-holder (1) according to the first aspect and embodiment, wherein the first strip (21) and second strip (25) are hingedly attached to the sleeve (10) at respective strip ends (23,27).

In accordance with a third embodiment of the first aspect and embodiment, there is disclosed a one-use bottle-holder (1) according to the second embodiment, wherein the first strip (21) and second strip (25) are arranged on the cardboard sleeve (10) such that each respective hinged attachment end (23,27) respectively rotates around a respective axis aligned either in parallel to the center axis or perpendicular to the center axis.

In accordance with a fourth embodiment of the first aspect and embodiment, there is disclosed a one-use bottle-holder (1) according to any of the preceding embodiments, wherein the joining means (22a-1) comprised on the first strip (21) are barbs or slits, which can engage into toothed engagement with the second strip (25) by inserting the first strip through cutout regions (26a-c) comprised in the second strip (25).

In accordance with a fifth embodiment of the first aspect and embodiment, there is disclosed a one-use bottle-holder (1) according to any of the preceding embodiments, wherein overlapping contact surfaces (41,42) form a backbone (43), and wherein the first and second strips (21,25) are arranged on the sleeve (10) to include the backbone (43) in the fastener (20).

In accordance with a sixth embodiment of the first aspect and embodiment, there is disclosed a one-use bottle-holder (1) according to any of the preceding embodiments, wherein the bottle-holder (1) further comprises at least a further two support cutouts arranged between the at least first and second support cutouts (30a,30b) and the aforementioned first and second strips (21,25).

In accordance with a seventh embodiment of the first aspect and embodiment, there is disclosed a one-use bottle-holder (1) according to any of the preceding embodiments, wherein a respective support cutout (30a,30b) comprises further hinges (31b-31d).

In accordance with a second aspect and first embodiment of the invention, there is disclosed a cardboard sleeve (10) comprising cutouts (21,25,30a,30b) and fold-lines (23,27,31a-e,31f-j,40a,40b), wherein when the cutouts are released from attachment to the cardboard sleeve, and the same cutouts are folded along the fold-lines, a one-use bottle-holder (1) for temporary attachment to an object according to any of the first to seventh embodiments of the first aspect is formed.

In accordance with a third aspect and first embodiment of the invention, there is disclosed a rectangular cardboard sheet (40) of height (h) and length (l) for forming a one-use bottle-holder (1), the sheet (40) comprising: two contact surfaces (41,42) comprising fold-lines (40a,40b) of height (h) and width (d4) arranged at opposite edges of the sheet (40); a first strip (21) and a second strip (25) respectively arranged on the sheet (40) towards a first edge (44) of the sheet (40), the first and second strip respectively cut out from the sheet except for a respective strip end (23,27) attaching each respective strip (21,25) to the sheet and forming a respective fold-line (23,27), and wherein on the first strip (21) there is cut out at least one first joining means (22a-1), and on the second strip (25) there is cut out at least one second and opposing joining means (26a-c) to the first joining means (22a-1); and at least a first and a second support cutout (30a,30b) of height (d1) arranged on the sheet (40) a distance (d2) from a second edge (45) of the sheet (40), the at least first and second support cutout (30a,30b) respectively cut out from the sheet at two cutout-lines and respectively attached to the sheet at respectively two opposing ends (31a,31e;31f,31j).

In accordance with a second embodiment of the third aspect of the invention, there is disclosed a rectangular cardboard sheet (40) according to the third aspect and first embodiment of the invention, wherein the first strip (21) and second strip (25) are arranged on the cardboard sheet (40) such that each respective strip end (23,27) is aligned either in parallel to or perpendicular to the second edge (45).

In accordance with a third embodiment of the third aspect of the invention, there is disclosed a rectangular cardboard sheet (40) according to the first and second embodiments of the third aspect of the invention, wherein the joining means (22a-1) comprised on the first strip (21) are barbs or slits, and the at least one second and opposing joining means (26a-c) to the first joining means (22a-1) are cutout regions comprised on the second strip (25).

In accordance with a fourth embodiment of the third aspect of the invention, there is disclosed a rectangular cardboard sheet (40) according to the first to third embodiments of the third aspect of the invention, wherein the cardboard sheet (40) further comprises at least a further two support cutouts arranged between the at least first and second support cutouts (30a,30b) and the aforementioned first and second strips (21,25).

In accordance with a fifth embodiment of the third aspect of the invention, there is disclosed a rectangular cardboard sheet (40) according to the first to fourth embodiments of the third aspect of the invention, wherein a respective support cutout (30a,30b) comprises further fold-lines (31b-31d) embossed on a respective support cutout.

In accordance with a sixth embodiment of the third aspect of the invention, there is disclosed a rectangular cardboard sheet (40) according to the first to fifth embodiments of the third aspect of the invention, wherein the strip ends (23,27) respectively are located on the sheet (40) a small distance of length (d3) from a respective fold-line (40a,40b), preferably from between 0 mm to 10 mm from a respective fold-lines (40a,40b).

In accordance with a seventh embodiment of the third aspect of the invention, there is disclosed a rectangular cardboard sheet (40) according to the first to sixth embodiments of the third aspect of the invention, wherein for the first and second support cutouts (30a,30b) of height (d1), the distance (d1) is at least 4 mm, and the distance (d2) is at least 10 mm.

In accordance with a fourth aspect and first embodiment of the invention, there is disclosed a method of folding a one-use cardboard bottle-holder (1) according to any of the first to seventh embodiments of the first aspect from a cardboard sheet (40) comprising cutouts (21,25,30a,30b) and fold-lines (23,27,31a-e,31f-j,40a,40b) according to any of the first to seventh embodiments of the third aspect of the invention, by forming a cardboard sleeve (10) from the cardboard sheet (40), releasing the cutouts (21,25,30a,30b) from attachment to the cardboard sleeve (10), and folding the same cutouts along the fold-lines (23,27,31a-e,31f-j, 40a,40b), to form the one-use bottle-holder (1).

### BRIEF DESCRIPTION OF THE DRAWINGS

FIG. 1: A bottle-holder according to the invention.

FIG. 2: A side-view of a bottle-holder according to the invention.

FIG. 3: A top-view showing first and second positions of the bottom supports.

FIG. 4: A cardboard sheet comprising cutouts and fold-lines for forming a bottle-holder of the invention.

### DETAILED DESCRIPTION

According to the first aspect of the invention there is presented a one-use bottle-holder (1) comprising: a cardboard sleeve (10), the sleeve forming an open, hollow cylinder around a cylinder center axis (CA) thereby defining an interior void (11) for receiving a bottle, and a first opening (12) and a second opening (13); a first strip (21) and a second strip (25) respectively arranged on the cardboard sleeve (10) towards the first opening, wherein on the first strip (21) there is arranged at least one first joining means (22a-1), and on the second strip (25) there is arranged at least one second and opposing joining means (26a-c), such that when the at least one first joining means (22a-1) is brought into engagement with the at least one second and opposing joining means (26a-c) a fastener (20) is formed; and at least a first support cutout (30a) and a second support cutout (30b), each the support cutout hingedly attached at two opposing ends (31a,31e; 31f,31j) to the cardboard sleeve (10) such that each support cutout (30a,30b) is displaceable between a first position, wherein a the support cutout (30a,30b) forms a part of the cardboard sleeve (10) and a second position, wherein a the support cutout (30a,30b) forms a part of a bottle-holder bottom (30), and wherein each respective hinged attachment end (31a,31e;31f,31j) respectively rotates around a respective axis, each respective axis aligned in parallel to the center axis.

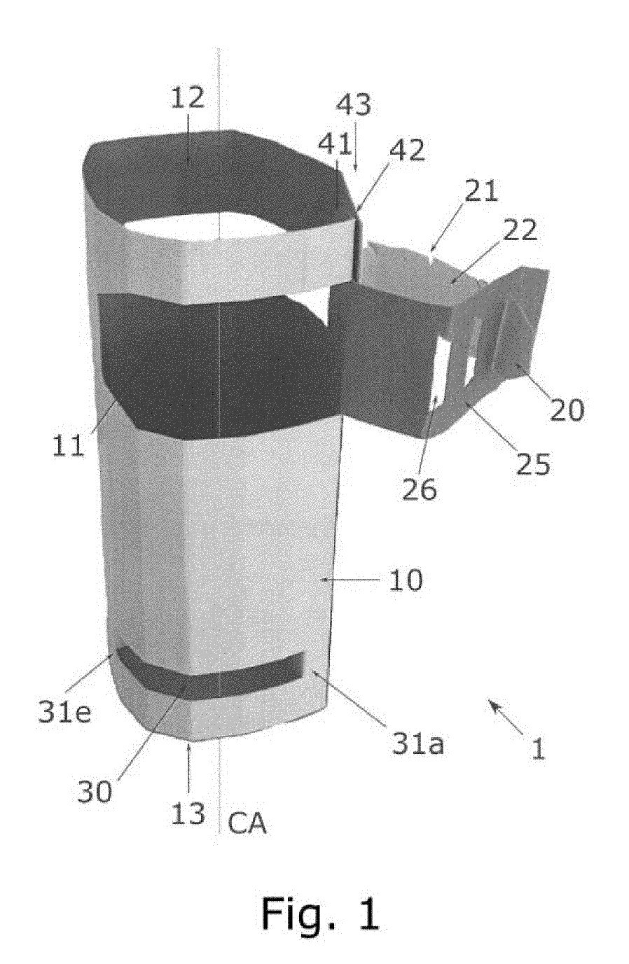

A preferred embodiment of the bottle-holder (1) of the invention is reproduced in FIG. 1.

The bottle-holder (1) of the invention comprises a cardboard sleeve (10), wherein the sleeve forms an open, hollow cylinder around a cylinder center axis (CA) thereby defining an interior void (11) for receiving a bottle, and a first opening (12) and a second opening (13). In the context of the present invention, sleeve shall be taken to mean that the diameter of the open, hollow cylinder formed by the sleeve has a diameter which is wide enough to receive a bottle within the hollow cylinder but narrow enough to prevent undesired movements of the bottle within the same hollow cylinder. For this purpose, the width of the diameter will typically not exceed the diameter of the bottle to be inserted by more than 25%, preferably by more than 20%, more preferably by more than 15% or most preferably by more than 10%. Further, in the context of the present invention, sleeve shall be taken to mean that the length of the open, hollow cylinder formed by the sleeve has a size which is short enough to receive a bottle within the hollow cylinder, while still providing access to the bottle by a user, when inserted into the bottle-holder, but long enough to prevent undesired movements of the bottle within the same hollow cylinder. Typical sleeve lengths are about ⅔ to ¾ the length of the bottle to be inserted.

It is the purpose of the invention that the bottle-holder of the invention shall be easy to manufacture by simple methodology and from cheap materials. Preferable, the materials can be disposed of without causing environmental problems. To obtain this result, the present invention therefore relates to one-use bottle-holders manufactured from cardboard. The present inventors and in the context of the present invention understand cardboard as a generic term for a heavy-duty paper of various strengths, ranging from a simple arrangement of a single thick sheet of paper to complex configurations featuring multiple corrugated and uncorrugated layers, as is common in the packaging industry.

On the cardboard sleeve (10) there is arranged a fastener (20) towards the first opening (12) and a bottom arranged on the cardboard sleeve (10) towards the second opening (13). Due to the symmetry of cylinders, the determination of which opening is the first or the second opening is therefore given by which opening is more proximate to the fastener and which opening is more proximate to the bottom.

The purpose of the fastener (20) is to allow the bottle-5 holder to become fastened to an object, and the purpose of the bottom arranged on the cardboard sleeve (10) is to support the bottle, in particular during transport of the bottle. In use, an in accordance with the invention, it is intended, that the fastener (20) is formed around an object to which the bottle-holder (1) of the invention shall be fastened, by joining the two opposing joining means (22a-1, 26a-c). Thereby the bottle-holder of the invention can be fastened to the object, e.g. a bike, during use.

In the context of the invention, the skilled person will realize that a bottle is both an object, and a container, and that accordingly, the bottle-holder of the invention effectively is a holder for an object, and a holder for a container. In the dictionary sense, a bottle is a rigid container with a bottleneck part that is narrower than the main container-body and a mouth-opening suitable for allowing a person to drink from the bottle. The skilled person will therefore realize that a cardboard sleeve (10) suitable for use with the invention must extend sufficiently from the bottom to the aforementioned first opening (12) such that a bottle contained in the interior void (11) will not fall out of the bottle-holder during transport. Below, the invention will be exemplified for a ½ l plastic bottle (water bottle) of a common design.

The bottle-holder comprising the fastener (20) and the bottle-holder bottom (30) as shown in the embodiment of FIG. 1, shows the fastener arranged in relative close proximity to the first opening (12), and the bottle-holder bottom (30) arranged in relative close proximity to the second opening (13), but this arrangement is, while preferred, not mandatory. Arranging the fastener and bottom in this manner saves material, as the sleeve thereby becomes as short as possible.

In general, the bottle-holder bottom (30) should always be constructed as close to the second opening (13) as permitted by the necessary material requirements, while retaining the ability to support a bottle at full filling and weight. The fastener (20), however, can be arranged also in the middle of the bottle-holder without negatively affecting the ability to attach the bottle-holder to an object. The actual determinant for the position of the fastener on the sleeve (10) is the center of gravity of the bottle to be contained in the sleeve, when the bottle is filled to its maximum with a liquid. If the fastener is arranged below the center of gravity of the filled bottle, such that both bottom (30) and fastener (20) are arranged with respect to the gravitational field of the earth below the center of gravity of the filled bottle, when the bottle is contained in the sleeve (10), then the bottle-holder (1) of the invention usually will not be sufficiently stable during transport, and the bottle may easily fall out of the sleeve.

The fastener (20) comprises a first strip (21) and a second strip (25) that are respectively arranged on the cardboard sleeve (10) and attached thereto. The embodiment of FIG. 1 shows the two strips arranged in relative close proximity to the first opening (12), but this arrangement is, while preferred, not mandatory, as explained above.

On the first strip (21) there is arranged at least one first joining means (22a-1), and on the second strip (25) there is arranged at least one second and opposing joining means (26a-c) to the first joining means, such that when the at least one first joining means (22a-1) is brought into engagement with the at least one second and opposing joining means (26a-c) the fastener is formed.

A fastener (20) suitable for use with the present invention and arranged on the sleeve (10) can be constructed in a number of ways. The embodiment shown in FIGS. 1, 2, and 4 all detail the situation wherein the first strip (21) comprises barbs (or slits) (22a-1), which can engage into toothed engagement with the second strip (25), by inserting the first strip through the cutout regions (26a-c). This embodiment is preferred as it assures the best attachment of the bottle-holder of the invention to a desired object, and further is simple to manufacture and use. However, one or more opposing slits on each strip can serve the same purpose of joining the strips (21,25) to form the fastener (20). In the alternative, it is possible to dispense with the second strip (25) and merely retain the cutout regions (26a-c) at their respective positions in the sleeve (10), but also this embodiment is less preferred as it is impractical in use. Further, the first strip (21) in this embodiment must be enlarged to ensure the necessary circumference, which has the disadvantage of increasing the strain on the fold-line (23) of the first strip to the sleeve during use.

It is preferred that the fastener (20) and the strips (21,25) shall be arranged on the sleeve (10) in proximity to first opening (12) rather than in proximity to the second opening (13) as depicted in FIGS. 1,2 and 4. This position allows a better distribution of the weight of the bottle when the bottle-holder is mounted on an object, and hence, increases the stability of the bottle-within-bottle-holder assembly during e.g. a bicycle ride.

The first (21) and second (25) strips can be manufactured independently of the sleeve (10) and attached to the sleeve (10) e.g. by gluing, at a later point, however, this is not preferred. Preferred, the first (21) and second (25) strips are strip cutouts from the sleeve and are hingedly attached at a respective strip end (23,27) to the cardboard sleeve (10) such that each strip cutout (21,25) is displaceable between a first position, wherein the strip cutout (21,25) forms a part of the cardboard sleeve (10) and a second position, wherein the strip cutout (21,25) forms a part of the fastener (20). In one embodiment, one of the strips (21,25) forms a part of the sleeve (10), which requires that the other strip is elongated to achieve a sufficient length of the fastener thereby compensating for the lacking strip.

The strips (21,25) can be arranged on the sleeve (10) in numerous manners, as long as the joining means (22a-1) and opposing joining means (26a-c) remain capable of engaging to form the fastener (20). Two preferred orientations are, a first orientation with the respective strip ends (23,27) hingedly attached to the sleeve (10) such that each respective hinged attachment end (23,27) respectively rotates around a respective axis, each respective axis aligned in parallel to the aforementioned center axis; and a second orientation with the respective strip ends (23,27) hingedly attached to the sleeve (10) such that each respective hinged attachment end (23,27) respectively rotates around a respective axis, each respective axis aligned perpendicular to the aforementioned center axis. In this manner, the bottle-holder can attach in one embodiment to a vertical element on a bike, and in the other embodiment to a horizontal element on a same bike. As it is difficult to accommodate the strips (21,25) as cutouts on the cardboard sleeve (10), when the strips are arranged as detailed for the second orientation of the respective strip ends (23,27), the above detailed solution with glued strips are preferably contemplated.

The bottle-holder (1) of the invention further comprises a bottle-holder bottom (30) arranged towards the second opening (13) of the cardboard sleeve (10). The bottle-holder bottom comprises at least a first support cutout (30a) and a second support cutout (30b), each of the support cutouts hingedly attached at two opposing ends (31a,31e; 31f,31j) to the cardboard sleeve (10) such that each support cutout (30a,30b) is displaceable between a first position, wherein the support cutout (30a,30b) forms a part of the cardboard sleeve (10) and a second position, wherein the support cutout (30a,30b) forms a part of the bottle-holder bottom (30), and wherein each respective hinged attachment end (31a,31e;31f,31j) respectively rotates around a respective axis, with each respective axis aligned in parallel to the aforementioned center axis.

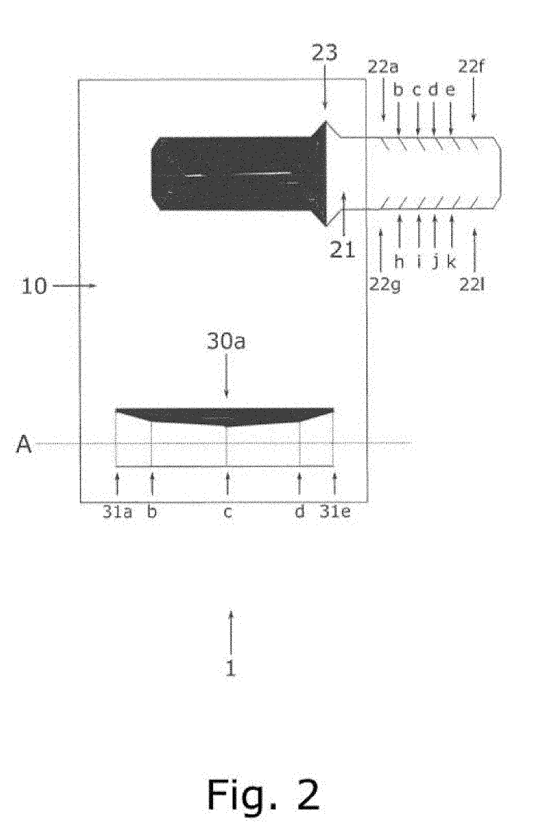

FIG. 2 shows a side-view of the bottle-holder of the invention where one of the support cutouts (30a) is shown in the position wherein the support cutout forms part of the bottom, i.e. is inside the void (11) formed by the sleeve. The hinges (31a,31e) are marked at the position where these attach the support cutout (30a) to the casing (10) together with further hinges (31b-31d), which are useful for permitting the support cutout (30a) to switch between the first position, wherein the support cutout forms a part of the sleeve (10), and the second position, wherein the support cutout (30a) forms a part of the bottle-holder bottom (30). When the bottle-holder (1) of the invention is manufactured from cardboard or other thin, potentially deformable material, the use of further hinges (31b-31d) aids in both forming and stabilizing the structure of the bottle-holder bottom (30), as well as in maintaining its structural stability when carrying a load.

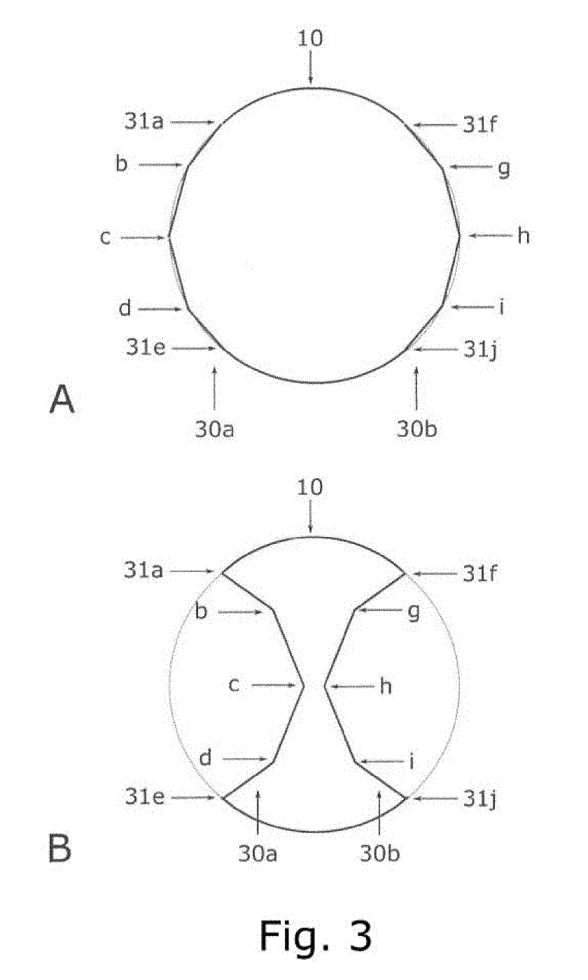

FIG. 3 depicts a top-view along the line A of FIG. 2 with respect to the support cutouts (30a,30b). FIG. 3A depicts the first position, where the support cutouts form part of the sleeve (10), and FIG. 3B depicts the second position, where the support cutouts s form part of the bottle-holder bottom 30. Also shown are the further hinges (31b-d,31g-i), which in accordance with the disclosure above, helps in forming the bottom (30) and increases its structural stability. It is advantageous to add at least one further hinge (31c,31h), preferably in the center of the support cutouts (30a,30b). The hinges (31a-j) are preferably oriented such that their axes of rotation are arranged in parallel to the aforementioned center axis (CA).

In order to transform the sleeve into a bottle-holder with a bottom, it is sufficient to exert a pressure large enough to displace the support cutouts from their position as part of the sleeve to their position as part of the bottom. Since, the main object of the present invention is to present solutions to the problem of attachable and detachable one-use bottle-holders, this force is small.

In a further embodiment of the invention, the bottle-holder (1) is provided with further at least two support cutouts arranged between the at least first and second support cutouts (30a,30b) and the aforementioned first and second strips (21,25). Thereby the bottle-holder is provided with a further bottom formable from the further at least two support cutouts. This embodiment enhances in a simple manner the versatility of the one-use bottle-holder (1) as bottles of different sizes can now fit into the void (11), while still being easy to reach for a person desiring this. Providing further layers of support cutouts arranged in the above manner further increases the versatility of use, but will, in some situations, have to be compensated for by increasing the thickness of the cardboard to maintain structural stability of the bottle-holder (1).

According to the invention there is further disclosed a rectangular cardboard sheet (40) of height (h) and length (1) for forming a one-use bottle-holder (1), the sheet (40) comprising: two contact surfaces (41,42) comprising fold-lines (40a,40b) of height (h) and width (d4) arranged at opposite edges of the sheet (40); a first strip (21) and a second strip (25) respectively arranged on the sheet (40) towards a first edge (44) of the sheet (40), the first and second strip respectively cut out from the sheet except for a respective strip end (23,27) attaching each respective strip (21,25) to the sheet and forming a respective fold-line (23,27), and wherein on the first strip (21) there is cut out at least one first joining means (22a-1), and on the second strip (25) there is cut out at least one second and opposing joining means (26a-c) to the first joining means (22a-1); and at least a first and a second support cutout (30a,30b) of height (d1) arranged on the sheet (40) a distance (d2) from a second edge (45) of the sheet (40), the at least first and second support cutout (30a,30b) respectively cut out from the sheet at respectively two cutout-lines and attached to the sheet at respectively two opposing ends (31a,31e;31f,31j).

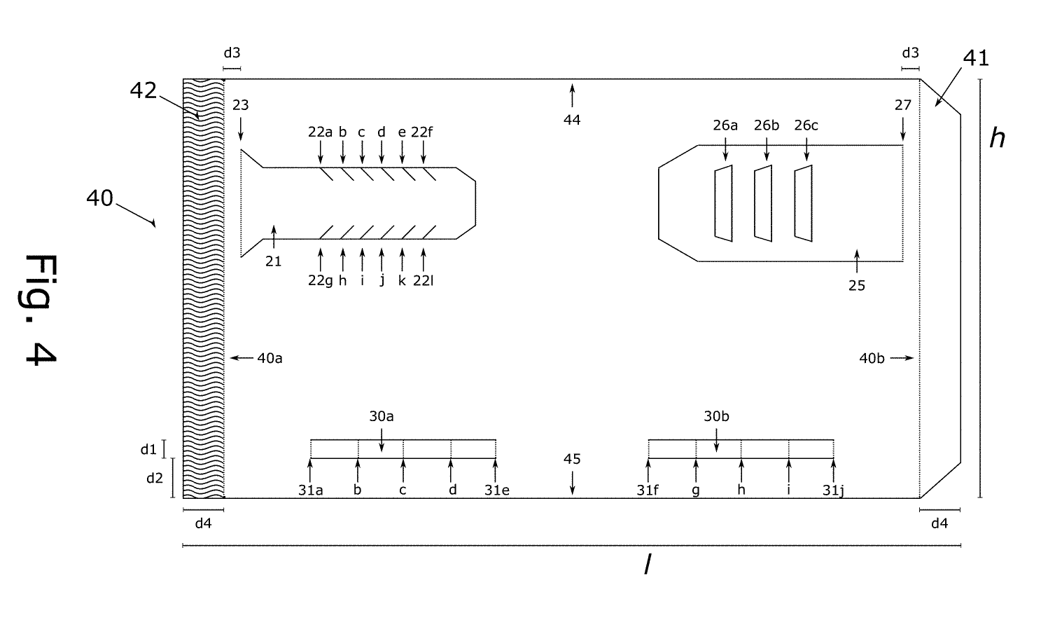

FIG. 4 details an overview of the cardboard sheet (40) of a preferred embodiment of the invention. The sheet (40), when folded to bring the first contact surface (41) into contact with the receiving second contact surface (42, wavy) will form a sleeve (10) as a precursor for the bottle-holder of the invention. For a standard ½ l bottle, an optimal width (d4) of the contact surfaces is between 8 mm to 12 mm, preferably 10 mm, which ensures an optimal attachment when glued with minimum waste of cardboard.

The overlapping region of the contact surfaces (41,42) form a backbone (43) for the bottle-holder, which, due to its double sheet thickness, will provide increased structural stability to the bottle-holder. Preferably, the strip cutouts (21,25) are arranged on the sheet (40) to include the backbone (43) in the fastener (20) when the sleeve (10) is formed from the sheet (40) by folding, thereby increasing the tensile strength of the fastener.

In the figure, fully drawn lines represent cut-lines along which, cutting or stamping through the sheet (40) is necessary, to allow folding of the support cutouts (30a,30b) and the strips (21,25) to form the bottom (30) of the bottle-holder (1) and the fastener (20) respectively. To manufacture the sleeve (10) the contact surfaces (41,42) must be permanently attached, preferably by gluing, in order to impart the necessary stability to the sleeve, such that it can support a filled bottle inside the void (11).

In the figure, there are further indicated fold-lines (40a,40b), together with hinges (23,27,31a-j), which advantageously shall be embossed in the manufacturing process, but not through-stamped or through-cut, to allow ease of bending of the constructional elements (21,25,30a,30b,41,42) attached to the sleeve along these lines. Further, embossing enhances the structural stability of the hinge over a user-formed hinge.

In FIG. 4 it is indicated that the fold-lines (23,27) of the strips (21,25) can be located on the sheet (40) a small distance of length (d3) from the fold-lines (40a,40b). This small distance can be from 0 mm to 10 mm, when the cardboard is 1 mm thick and the bottle to be inserted into the bottle-holder is a standard ½ l bottle of about 70 mm in diameter. Preferably, the distance (d3) is from 0 mm to 6 mm, most preferably from 2 mm to 4 mm, as the fold-lines (40a,40b) are then able to support a larger load due to the proximity to the glued backbone of double sheet thickness.

Also indicated in the drawing are distances (dl) and (d2). For a standard cardboard sheet of 1 mm for use in manufacturing the bottle-holder of the invention for supporting the weight of a water filled standard ½ l bottle of 70 mm diameter, the distance (d1) should at least be 4 mm, preferably 4 mm to 8 mm, more preferably 5 mm to 6 mm, most preferably 5 mm, and the distance (d2) should at least be 10 mm, preferably 10 mm to 20 mm, more preferably 13 mm to 17 mm, 25 and most preferably 15 mm.

In accordance with a final aspect of the invention, there is also disclose a method of folding a one-use cardboard bottle-holder (1) according to any of the embodiments and aspects as mentioned in this disclosure from a cardboard sheet (40) comprising cutouts (21,25,30a,30b) and fold-lines (23,27,31a-e,31f-j,40a,40b) as detailed in any of the embodiments and aspects in this disclosure, by forming a cardboard sleeve (10) from the cardboard sheet (40), releasing the cutouts (21,25,30a,30b) from attachment to the cardboard sleeve (10), and folding the same cutouts along the fold-lines (23,27,31a-e,31f-j,40a,40b), to form the one-use bottle-holder (1).

### Closing Comments

The term “comprising” as used in the claims does not exclude other elements or steps. The term “a” or “an” as used in the claims does not exclude a plurality. A single processor or other unit may fulfill the functions of several means recited in the claims.

Although the present invention has been described in detail for purpose of illustration, it is understood that such detail is solely for that purpose, and variations can be made therein by those skilled in the art without departing from the scope of the invention.

1. A one-use bottle-holder comprising:
a cardboard sleeve, said sleeve forming an open, hollow cylinder around a cylinder center axis (CA) thereby defining an interior void for receiving a bottle, and a first opening and a second opening;
a first strip and a second strip respectively arranged on said cardboard sleeve towards said first opening, wherein on said first strip there is arranged at least one first joining means, and on said second strip there is arranged at least one second and opposing joining means, such that when said at least one first joining means is brought into engagement with said at least one second and opposing joining means a fastener is formed; and
at least a first support cutout and a second support cutout, each said support cutout hingedly attached at two opposing ends to said cardboard sleeve such that each support cutout is displaceable between a first position, wherein a said support cutout forms a part of said cardboard sleeve and a second position, wherein a said support cutout forms a part of a bottle-holder bottom, and wherein each respective hinged attachment end respectively rotates around a respective axis, each respective axis aligned in parallel to said center axis.

2. A one-use bottle-holder according to claim 1, wherein said first strip and second strip are hingedly attached to said sleeve at respective strip ends.

3. A one-use bottle-holder according to claim 2, wherein said first strip and second strip are arranged on said cardboard sleeve such that each respective hinged attachment end respectively rotates around a respective axis aligned either in parallel to said center axis or perpendicular to said center axis.

4. A bottle-holder according to claim 1, wherein said joining means comprised on said first strip are barbs or slits, which can engage into toothed engagement with said second strip by inserting said first strip through cutout regions comprised in said second strip.

5. A bottle-holder according to claim 1, wherein overlapping contact surfaces form a backbone, and wherein said first and second strips are arranged on said sleeve to include said backbone in said fastener.

6. A bottle-holder according to claim 1, wherein said bottle-holder further comprises at least a further two support cutouts arranged between said at least first and second support cutouts and said first and second strips.

7. A bottle-holder according to claim 1, wherein a respective support cutout comprises further hinges.

8. A cardboard sleeve comprising cutouts and fold-lines wherein when said cutouts are released from attachment to said cardboard sleeve, and said same cutouts are folded along said fold-lines, a one-use bottle-holder for temporary attachment to an object according to any of the preceding claims is formed.

9. A rectangular cardboard sheet of height (h) and length (l) for forming a one-use bottle-holder comprising:
two contact surfaces comprising fold-lines of height (h) and width (d4) arranged at opposite edges of said sheet;
a first strip and a second strip respectively arranged on said sheet towards a first edge of said sheet, said first and second strip respectively cut out from said sheet except for a respective strip end attaching each respective strip to said sheet and forming a respective fold-line, and wherein on said first strip there is cut out at least one first joining means, and on said second strip there is cut out at least one second and opposing joining means to said first joining means (22a-1); and
at least a first and a second support cutout of height (dl) arranged on said sheet a distance (d2) from a second edge of said sheet, said at least first and second support cutout respectively cut out from said sheet at two cutout-lines and respectively attached to said sheet at respectively two opposing ends.

10. A rectangular cardboard sheet according to claim 9, wherein said first strip and second strip are arranged on said cardboard sheet such that each respective strip end is aligned either in parallel to or perpendicular to said second edge.

11. A rectangular cardboard sheet according to claim 9, wherein said joining means comprised on said first strip are barbs or slits, and said at least one second and opposing joining means to said first joining means are cutout regions comprised on said second strip.

12. A rectangular cardboard sheet according to claim 9, wherein said cardboard sheet further comprises at least a further two support cutouts arranged between the at least first and second support cutouts and the aforementioned first and second strips.

13. A rectangular cardboard sheet according to claim 9, wherein a respective support cutout ) comprises further fold-lines embossed on a respective support cutout.

14. A rectangular cardboard sheet according to claim 9, wherein said strip ends respectively are located on said sheet a small distance of length (d3) from a respective fold-line, preferably from between 0 mm to 10 mm from a respective fold-lines.

15. A rectangular cardboard sheet according to claim 9, wherein for said a first and a second support cutout of height (dl), said distance (dl) is at least 4 mm, and said distance (d2) is at least 10 mm.

16. A method of folding a one-use cardboard bottle-holder according to claim 1 from a cardboard sheet comprising cutouts and fold-lines according to claim 9, by forming a cardboard sleeve from said cardboard sheet, releasing said cutouts from attachment to said cardboard sleeve, and folding said same cutouts along said fold-lines, to form said one-use bottle-holder.
